(19) United States
(12) Patent Application Publication
(10) Pub. No.: US 2005/0150110 A1
(43) Pub. Date: Jul. 14, 2005

(54) Part having passages and technique for providing same

(76) Inventor: Rodney M. Kramer, Rockford, IL (US)

Correspondence Address: MCDERMOTT, WILL & EMERY LLP, 227 WEST MONROE STREET, CHICAGO, IL, 60606-5096, US

(21) Appl. No.: 11/031,314

(22) Filed: Jan. 7, 2005

Related U.S. Application Data
(60) Provisional application No. 60/535,033, filed on Jan. 8, 2004.

(51) Int. Cl. F16C 23/04

(52) U.S. Cl. 29/890.143; 29/890.142

(57) ABSTRACT

The present invention provides a part having passages from an internal surface to an external surface formed by the intersection of internal and external grooves. The present invention further provides a method of providing a part having passages from an internal surface to an external surface formed by the intersection of internal and external grooves. The part includes at least one internal groove located in an internal surface and at least one external groove located in an external surface, wherein the internal groove and the external groove intersect to form at least one passage between the internal surface and the external surface.

### TECHNICAL FIELD

The present subject matter relates generally to a part having passages and a manufacturing technique for providing the same. More specifically, the present invention relates to a part having passages allowing flow to pass between an inner surface and external surface of the part. The present invention further includes a technique for providing passages between an inner surface and an outer surface in a part.

### BACKGROUND

There were known techniques for producing parts having passageways from an inner surface to an outer surface. For example, diffuser caps, spray nozzles, and other similar devices often used such parts to pass liquids and/or gasses from an inner surface to an outer surface at a predetermined controlled flow rate.

The manufacture of parts having passageways from an inner surface to an outer surface was often costly and time consuming. For example, diffuser caps were manufactured by producing a diffuser cap blank, turning the blank on a lathe to form the external shape of the part, punching or drilling the required passageways in the part and removing the burrs created by the punching or drilling process. Punching or drilling the requisite passageways often required the use of a custom fixture developed for and corresponding to the unique configuration of the part to be manufactured. These custom fixtures were often very expensive pieces and were only useful for producing one specific product in one specific configuration. Any substantive design modification in the part often resulted in the obsolescence of the custom fixture.

### SUMMARY

The present invention provides a part having passages and a manufacturing technique for providing the same. More specifically, the present invention provides a part having passages allowing flow to pass between an inner surface and external surface of the part. The present invention further provides a technique for providing passages between an inner surface and an outer surface in a part.

The part of the present invention includes intersecting internal and external grooves, which form passages at their intersections. The part of the present invention may be machined, cast, molded, hot forged or otherwise manufactured. The present invention eliminates the need to drill and/or punch manufactured parts to provide passages therein. Eliminating the requirement of drilling and/or punching eliminates the need to use costly custom fixtures and further eliminates the costs and time associated with removing the burrs caused by drilling and/or punching.

The method of the present invention includes the steps of: (1) providing a part having an internal surface and an external surface; (2) providing internal grooves along the internal surface of the part; and (3) providing external grooves that intersect with the internal grooves to form passageways from the internal surface of the part to the external surface of the part.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF DRAWINGS

The drawing figures depict one or more implementations in accord with the present concepts, by way of example only, not by way of limitations. In the figures, like reference numerals refer to the same or similar elements.

FIG. 1 is a side view of a machined part of the present invention.

FIG. 2 is a longitudinal cross-sectional view of the machined part shown in FIG. 1 taken along section line A-A.

FIG. 3 is a perpendicular cross-sectional view of the machined part shown in FIG. 1 taken along section line B-B.

FIG. 4 is a flow chart illustrating a method of providing a part having passages according to the present invention.

### DETAILED DESCRIPTION

FIG. 1 illustrates an embodiment of a part 10 of the present invention. The part 10 shown in FIG. 1 is a diffuser cap; however, the machined part 10 of the present invention is not limited in application as diffuser caps. Parts made in accordance with the present invention may be utilized as diffuser caps, spray nozzles, or in any other application requiring the passage of liquid and/or gas from an internal surface to an external surface.

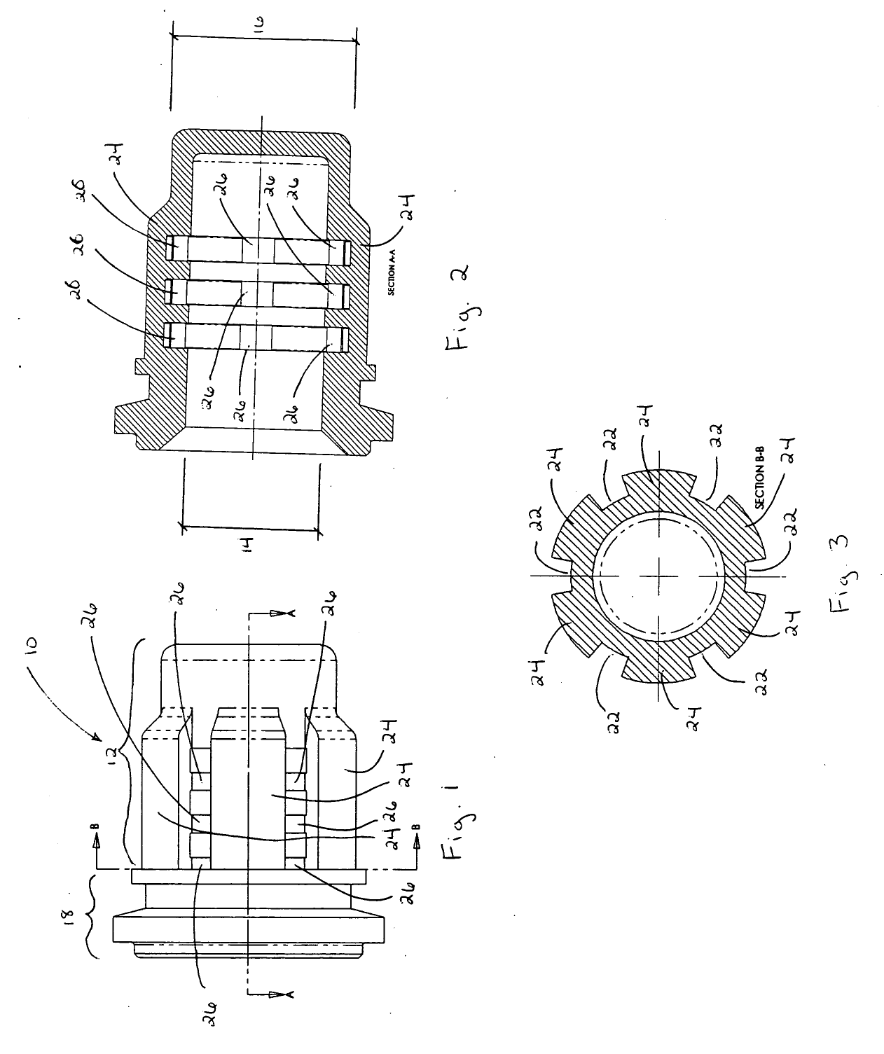

The part 10 of FIG. 1 includes a diffuser portion 12 having passages passing from an internal diameter 14 to an external channel diameter 16, as shown in FIG. 2. The part 10 of FIG. 1 also includes a inlet adaptation portion 18 for attaching the part 10 to a source for providing liquid and/or gas to be passed through the part 10. The configuration of the inlet adaptation portion 18 corresponds to the mounting portion of the source device (not shown) to which the part 10 is to be attached.

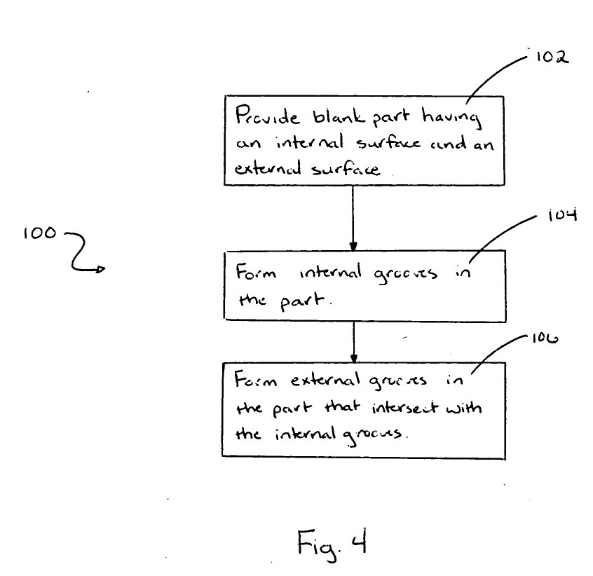

As shown in FIG. 2, the internal geometry of the diffuser portion 12 is a generally smooth bore having three circumferential internal grooves 20, or channels, configured thereon. As further shown in FIG. 3, the external geometry of the diffuser portion 12 includes six longitudinal external grooves 22 creating a spline-like external appearance along the diffuser portion 12 of the part 10. Accordingly, the diffuser portion 12 of the part 10 includes six rib portions 24, as shown in FIG. 3. The internal grooves 20 and external grooves 22 may be any shape. For example, the internal grooves 20 and external grooves 22 may be generally U-shaped, generally V-shaped, etc. Neither the part 10, nor any portion of the part 10, such as, for example, the diffuser portion 12 of the part 10, is required to be circular in cross-section. In fact, the part 10 may be any shape having an internal and external surface.

As shown in FIG. 2, the rib portions 24 extend outward beyond the external channel diameter 16. However, the external grooves 22 are provided such that their depth corresponds to the external channel diameter 16. Accordingly, passages 26 from the internal diameter 14 to the external channel diameter 16 are formed at the intersections of the internal grooves 20 and the external grooves 22. The number of passages 26 corresponds to the number of intersections between the internal grooves 20 and the external grooves 22. In the configuration of the part 10 shown in FIGS. 1-3, there are eighteen intersections and therefore eighteen passages 26. The size of each of the passages 26 is determined by the width of the internal grooves 20 and the external grooves 22. Further, the shape of the passages 26 is determined by the shape and the angle of intersection of the internal grooves 20 and the external grooves 22. By changing the configuration of the internal grooves 20 and/or the external grooves 22, the number, shape and size of the passages 26 may be altered. The size of the passages 26 can be controlled for precise metering of flow through the passages 26.

For example, a single continuous internal grooves 20 may be provided in a helical configuration such that the number of passages 26 is determined by the number of intersections made between the internal groove 20 and the external grooves 22. In one example, a single continuous helical internal groove 20 may be provided to intersect each of eight external grooves 26 three times to form a total of eighteen passages 26. Similarly, a single external groove 22 may be utilized. Other non-parallel configurations between the internal grooves 20 and the external grooves 22 may be utilized in accordance with the present invention. Moreover, the internal grooves 20 may be formed longitudinally along the part 10 and the external grooves 22 may be formed circumferentially along the part 10.

The part 10 shown in FIGS. 1-3 is a machined part. The external configuration of the part 10 and the internal diameter 14 of the part may be formed in a die of a cold header of a cold heading machine. The internal grooves 20 shown in FIGS. 1-3 may be formed using a lathe and a boring bar. Alternatively, the internal grooves 20 may be formed using a mill and circular interpolation with a keyway cutter. By eliminating the need for drilling or punching, the present invention eliminates the need for custom fixtures when providing a part having passages from an internal surface to an external surface, such as a diffuser cap and further eliminates the need to remove the burrs created by drilling or punching passages in a part. However, the internal grooves 20 and external configuration of the part 10, including the external grooves 22 may be formed in any manner. Further, the part 10 shown in FIGS. 1-3 may be cast, molded, hot forged, or otherwise manufactured without the need for machining processes.

FIG. 4 illustrates a method of forming a part having passages according to the present invention. The method shown in FIG. 4 includes a first step providing a blank part having an internal surface and an external surface 102. The method 100 further includes a second step of forming internal grooves in the part 104. The method 100 includes a third step of forming external grooves in the part that intersect with the internal grooves 106. The intersection of the internal and external grooves may be made by ensuring the external grooves are provided with a depth that corresponds to the outer diameter of the internal grooves. The sequence of the second step 104 and the third step 106 of the method 100 shown in FIG. 4 may be reversed. Alternatively, the second step 104 and the third step 106 of the method 100 shown in FIG. 4 may be performed simultaneously.

Although the description above has been directed towards parts having circular cross-sections along the internal and external diameters, the invention is equally applicable to parts having other internal and external shapes. For example, the internal diameter may be square-shaped instead of circular. Accordingly, the use of the terms internal diameter and external diameter in the description should be understood to apply to non-circular shapes.

It should be noted that various changes and modifications to the presently preferred embodiments described herein will be apparent to those skilled in the art. Such changes and modifications may be made without departing from the spirit and scope of the present invention and without diminishing its attendant advantages.

1. A machined part comprising:
an internal surface;
an external surface surrounding at least a portion of said internal surface;
at least one internal groove located in said internal surface; and
at least one external groove located in said external surface, wherein said internal groove and said external groove intersect to form at least one passage between said internal surface and said external surface.

2. The machined part of claim 1 further comprising an inlet adapter portion for attaching the machined part to another device.

3. The machined part of claim 1 wherein said internal surface is a circular cylindrical surface.

4. The machined part of claim 1 wherein said internal groove is a U-shaped groove.

5. The machined part of claim 1 wherein said at least one internal groove comprises three circumferential internal grooves.

6. The machined part of claim 1 wherein said at least one internal groove comprises at least one helical internal groove.

7. The machined part of claim 1 wherein said at least one external groove is a V-shaped groove.

8. The machined part of claim 1 wherein said at least one external groove comprises six longitudinal external grooves.

9. The machined part of claim 1 wherein said at least one external groove comprises at least one helical external groove.

10. The machined part of claim 1 wherein the machined part is a diffuser cap.

11. A method of forming a part having a passage comprising the steps of:
providing a part comprising an internal surface and an external surface;
forming at least one internal groove in said internal surface of said part; and
forming at least one external groove in said external surface of said part, wherein said internal groove and said external groove intersect to form at least one passage between said internal surface and said external surface.

12. The method of claim 11 wherein said part further comprises an inlet adapter portion for attaching the machined part to another device.

13. The method of claim 11 wherein said internal surface is a circular cylindrical surface.

14. The method of claim 11 wherein said at least one internal groove comprises at least one helical internal groove.

15. The method of claim 11 wherein the part is a diffuser cap.

16. A diffuser cap comprising:
an inlet adapter portion; and
a diffuser portion connected to said inlet adapter portion, wherein said diffuser portion includes an internal surface and an external surface surrounding at least a portion of said internal surface, further wherein said diffuser portion includes at least one internal groove located in said internal surface and at least one external groove located in said external surface, wherein said internal groove and said external groove intersect to form at least one passage between said internal surface and said external surface.

17. The diffuser cap of claim 16 further comprising an inlet adapter portion for attaching the diffuser cap to another device.

18. The diffuser cap of claim 16 wherein said internal surface is a circular cylindrical surface.

19. The diffuser cap of claim 16 wherein said at least one internal groove comprises at least one helical internal groove.

20. The diffuser cap of claim 16 wherein said at least one external groove comprises at least one helical external groove.
